(19) United States
(12) Patent Application Publication
(10) Pub. No.: US 2010/0314875 A1
(43) Pub. Date: Dec. 16, 2010

(54) SYSTEM AND METHOD FOR CONTROLLING A WIND TURBINE

(76) Inventor: Christopher Bernard Grant, Long Sault (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/781,567

(22) Filed: May 17, 2010

Related U.S. Application Data
(60) Provisional application No. 61/178,692, filed on May 15, 2009.

(51) Int. Cl. H02P 9/04

(52) U.S. Cl. 290/44

(57) ABSTRACT

A system for controlling the RPM of a wind turbine comprising using inverters to draw current from the wind turbine, thereby slowing the rotational speed of the wind turbine blades. In another aspect, a resistor and a switching mechanism attached between the resistor and a phase line is provided to increase the load on the phase line. A yaw motor is also used to yaw the facing direction of the wind turbine out of the wind. Moreover, a normally closed switching mechanism can redirect current from a phase line through a resistor. A normally closed brake is also used to mechanically engage the turbine when the control system fails. A normally open yawing clutch when disengaged allows the nacelle of the wind turbine to rotate freely into the down wind direction. The system also comprises a switch that can create an electrical short between the phase lines of the turbine.

### CROSS REFERENCE TO RELATED APPLICATIONS

This application claims priority from U.S. Provisional Application No. 61/178,692 filed on May 15, 2009; the contents of which are incorporated herein by reference.

### TECHNICAL FIELD

The present invention relates to methods and apparatus for the control of a wind turbine.

### DESCRIPTION OF THE RELATED ART

Electrical power can be generated by using wind to turn the blades of a wind turbine. The blades are connected to the rotor of an electrical generator that cooperates with a stator to generate an electrical current in a well known manner. The electrical power output of the turbine will vary depending on the speed of rotation of the blades. The faster the blades spin, the greater the voltage that can be generated and accordingly it is preferable to have the highest practical rotational speed. However, if the blades spin too fast, damage may be caused to the electrical components because of an excessively high voltage or may occur to the structure of the turbine due to mechanical stress and vibrations. On the other hand, if rotation of the blades is unduly restricted, by the imposition of a high electrical load for example, to accommodate anticipated extreme wind conditions, then the generating potential at normal operating ranges may be adversely affected. Thus, there is a desire to control the rotation speed of the wind turbine whilst optimising the output over a range of operating conditions.

The control of a wind turbine is particularly challenging due to the variability of the prime energy source, namely the wind, which can change in speed and direction. The generator will typically produce an alternating current output and the frequency of that output will vary as the rotational speed varies. The fluctuations in speed due to wind gusts are highly unpredictable and it is difficult to discriminate between a gust and a sustained increase in wind speed. Accordingly, normal control algorithms associated with electrical power generation are generally unsatisfactory.

It is known to control the power output by controlling the operation of the inverter used to condition the raw power received from the generator into a form acceptable to the utility. By varying the operating conditions of the inverter, the electrical load placed on the generator may be varied which in turn controls the rotational speed of the blades. However, due to the variability of the wind, the control available from adjustment of the inverter may not be sufficient.

It has also been proposed to extend the range of operation of the control by selectively increasing the electrical load on the generator. The imposition of such a load is difficult to control due to the unpredictability of the wind and may result in inefficiencies if the load is simply dissipated as heat.

It is therefore desirable that the present invention obviates or mitigates at least one of the above disadvantages.

### SUMMARY OF THE INVENTION

A system for controlling a wind turbine is provided comprising using inverters to draw current from the wind turbine, thereby slowing down the rotational speed of the wind turbine blades. In another aspect, the system comprises a resistor and a switching mechanism attached between the resistor and a phase line, whereby the switching mechanism is activated for certain times to chop or pulse the voltage on the phase line. In another aspect, the system comprises a yaw motor to yaw the facing direction of the wind turbine out of the wind to reduce aerodynamic forces on the blades of the turbine. In another aspect; the system comprises a normally closed switching mechanism that is electrically connected in parallel to the other switching mechanism, whereby failure to control the system would redirect current from a phase line through the normally closed switching mechanism through a resistor to slow down or stop the wind turbine blades from rotating. In yet another aspect, the system comprises a primary and a secondary normally closed brake in connection with the generator shaft, whereby failure to control the system would cause both of the normally closed brakes to mechanically engage the generator shaft to slow down or stop the wind turbine blades from rotating. In yet another aspect, the system comprises a normally open yawing clutch, whereby failure to control the system would disengage the normally open yawing clutch and allow the nacelle of the wind turbine to rotate freely into the down wind direction, such that aerodynamic forces against the back of the wind turbine blades would generate little or no rotational force. In yet another aspect, the system comprises a shunt switch that, when closed, would create an electrical short between the phase lines of the turbine to slow down or stop the wind turbine blades from rotating.

In another aspect, a method is provided for controlling the rotation speed of a rotor having one or more blades on a wind turbine. The method comprises determining the yaw angle of the wind turbine relative to the wind direction. Then the yaw angle of the wind turbine is changed to increase or decrease the aerodynamic efficiency of the one or more blades, thus, controlling the rotation speed of the one or more blades. In another aspect, the method includes a controller sending a command to the yaw motor, and the yaw motor changing the yaw angle of the wind turbine. One or more sensors may measure the direction of the wind and send the wind direction measurements to the controller. The controller then determines the yaw angle of the wind turbine relative to the wind direction based on the measurements. The one or more sensors may include a wind vane. The yaw angle of the wind turbine is changed to decrease the rotation speed of the one or more blades when the wind speed reaches a predetermined upper limit.

In another aspect, a system is provided for controlling the yaw angle of a nacelle on a wind turbine. The system comprises a normally open yaw clutch mechanically connected between a yaw motor and the nacelle. The yaw clutch is able to move to a closed position when power is applied to the yaw clutch and is able to move to an open position in the absence of power. In the closed position, the yaw motor is mechanically engaged to the nacelle to control the yaw angle of the nacelle, and, in the open position, the yaw motor is disengaged from the nacelle and the nacelle is able to yaw independently from the yaw motor. The system also includes one or more blades that are rotatably connected to the nacelle. The one or more blades comprising a front surface and a back surface, whereby the back surface has a less aerodynamic shape than the front surface. Therefore, when the yaw clutch is in the open position, the nacelle yaws freely to face down wind so that the wind blows against the back surface of the one or more blades and, thus, reduces the rotational speed of the one or more blades. The system also includes a controller to control the yaw motor and the yaw angle of the nacelle, as well as to control the opening and closing of the yaw clutch. When there is a loss of power to the controller, the yaw clutch moves to the open position.

The nacelle of the above system may also yaw about a support and include a stationary ring gear on the support. The yaw motor is mounted in the nacelle, whereby the yaw motor configured to drive a shaft. The yaw clutch is interposed between a spur gear and the shaft, and the spur gear is mechanically engaged with the ring gear. Therefore, when the yaw clutch is in the closed position, the spur gear and the shaft are mechanically connected and, when the yaw clutch is in the open position, the spur gear and the shaft are disengaged. In another aspect, the yaw clutch is electro magnetic.

In another aspect, a system for controlling a wind turbine is provided. The system includes a wind turbine generator powered by the rotation of a rotor having one or more blades of the wind turbine; an inverter electrically connected to the generator, the inverter able to increase the electrical current drawn from the generator to reduce the rotational speed of the one or more blades; a resistor and a switch, the switch electrically connected between the resistor and the generator, whereby the switch is closed and opened repeatedly to pulse the voltage produced from the generator, thereby reducing the rotational speed of the one or more blades; and, a controller that is configured to repeatedly open and close the switch upon detecting that the current draw from the inverter has reached a current draw limit or that the rotational speed of the one or more blades has reached a rotational speed limit.

In another aspect, the wind turbine of the above system comprises a nacelle that holds the generator, and the system further comprises a yaw motor mechanically engaged with the nacelle to change the yaw angle of the nacelle, the yaw motor controlled by the controller. The controller is configured to change the yaw angle of the nacelle relative to the direction of the wind to reduce the rotational speed of the one or more blades, upon detecting that the one or more blades has reached the rotational speed limit.

In another aspect, the controller is configured to change the yaw angle of the nacelle to reduce the rotational speed of the one or more blades also upon detecting that the length of time that the switch has been closed and opened repeatedly to pulse the voltage has reached a time limit.

In another aspect, the system further comprises a normally closed switch that is electrically connected in parallel to the switch, whereby when power is applied to the normally closed switch, the normally closed switch is in an open position, and in the absence of power, the normally closed switch is in a closed position to direct current from the generator to the resistor, thereby reducing the rotational speed of the one or more blades.

In another aspect, the normally closed switch is controlled by the controller, and the controller is configured to close the normally closed switch upon detecting that the one or more blades has reached the rotational speed limit.

In another aspect, the system further comprises a normally closed brake able to mechanically engage a generator shaft, whereby when power is not applied to the normally closed brake, the normally closed brake is in a closed position engaging the generator shaft to reduce the rotational speed of the one or more blades.

In another aspect, the system further comprises: a normally open yaw clutch mechanically connected between the yaw motor and the nacelle; the yaw clutch able to move to a closed position when power is applied to the yaw clutch and able to move to an open position in the absence of power; and, wherein, in the open position, the yaw motor is disengaged from the nacelle and the nacelle is able to yaw freely to face down wind so that the wind blows against a back surface of the one or more blades, the back surface shaped to be less aerodynamic than a front surface of the one or more blades, so that when facing down wind, the rotational speed of the one or more blades is reduced.

In another aspect, at least a first and a second power line are electrically connected to the generator, and the system further comprises a shunt switch that, when closed, produces an electrical short between the first and second power lines of the generator to reduce the rotational speed of the one or more blades.

In another aspect, the controller is configured to activate a first control combination comprising increasing the current draw from the inverter and repeatedly opening and closing the switch, upon detecting that the rotational speed limit has been reached. The controller is also configured to activate a second control combination comprising changing the yaw angle of the nacelle and activating the first control combination, upon detecting that the rotational speed limit has been reached while the first control combination is active. The controller is also configured to activate a third control combination comprising closing the normally closed switch and activating the second control combination, upon detecting that the rotational speed limit has been reached while the second control combination is active. The controller is also configured to activate a fourth control combination comprising closing the normally closed brakes and activating the third control combination, upon detecting that the rotational speed limit has been reached while the third control combination is active. The controller is also configured to activate a fifth control combination comprising opening the normally open yaw clutch and activating the fourth control combination, upon detecting that the rotational speed limit has been reached while the fourth control combination is active. The controller is also configured to activate a sixth control combination comprising closing the shunt and activating the fifth control combination, upon detecting that the rotational speed limit has been reached while the fifth control combination is active.

### BRIEF DESCRIPTION OF THE DRAWINGS

Embodiments of the invention will now be described by way of example only with reference to the appended drawings wherein:

FIG. 1 is a system diagram of a wind turbine in connection with a power controller and electrical grid.

FIG. 2 is a system diagram of the power controller in FIG. 1 in connection with the wind turbine.

FIG. 3 is a system diagram of wind turbine sensors housed in the wind turbine in FIG. 2.

FIG. 4 is system diagram showing the controller in communication with wind turbine sensors, an inverter and a database.

FIG. 5 is a flow diagram showing a method of chopping or pulsing voltage.

FIG. 6 is an example voltage waveform signal being chopped or pulsed.

FIG. 7 is a perspective view of a nacelle of a wind turbine.

FIG. 8 is a cross-sectional perspective view of the nacelle in FIG. 7.

FIG. 9 is a rear perspective view of the nacelle in FIG. 7 with portions removed for clarity.

FIG. 10 is a cross-sectional view of the nacelle of FIG. 7.

FIG. 11 is a perspective view of the yaw motor assembly shown in isolation.

FIG. 12 is a cross-sectional view of the yaw motor assembly in FIG. 11.

FIG. 13 is a flow diagram showing a method of employing the control mechanisms in serial.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

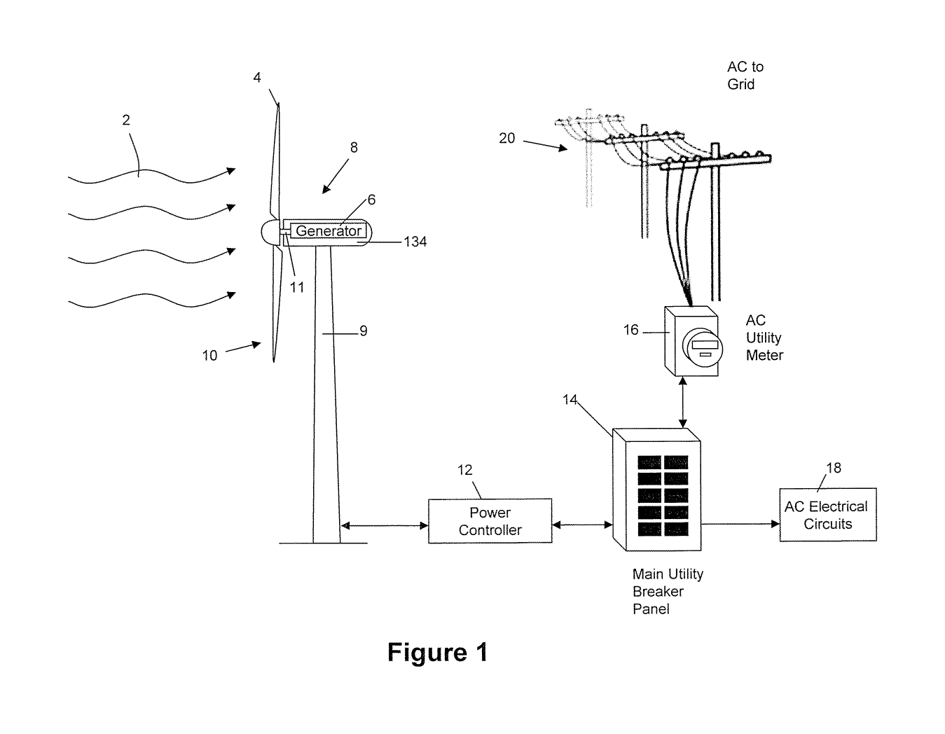

Referring therefore to FIG. 1, a wind turbine 8 is employed to supply electrical power to dedicated circuits 18, or, where surplus power is available, to an electrical grid 20. The wind turbine 8 is electrically connected to a power controller 12 which in turn is electrically connected to a utility breaker panel 14. The utility breaker panel 14 may then distribute the power generated from the wind turbine 8 to electrical circuits 18 and a utility meter 16 linking into a larger power grid 20.

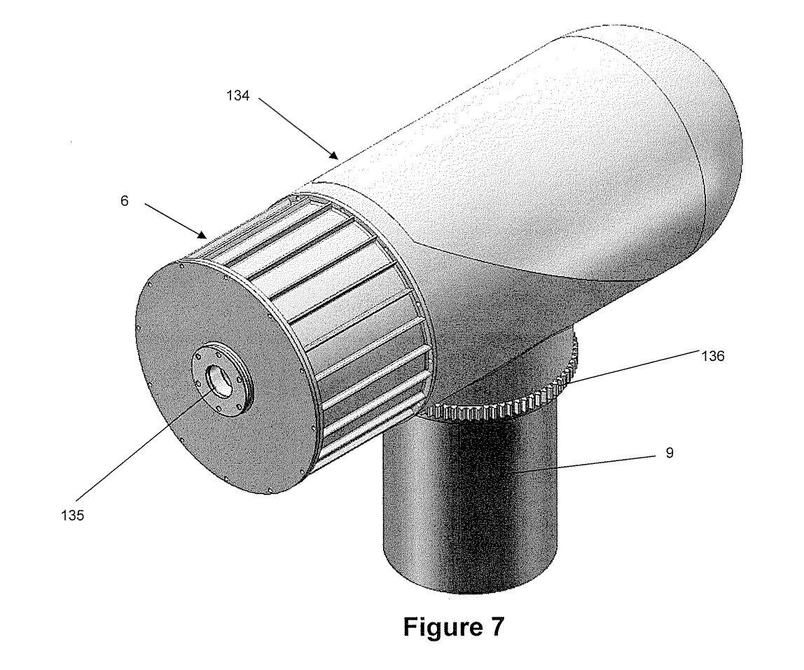

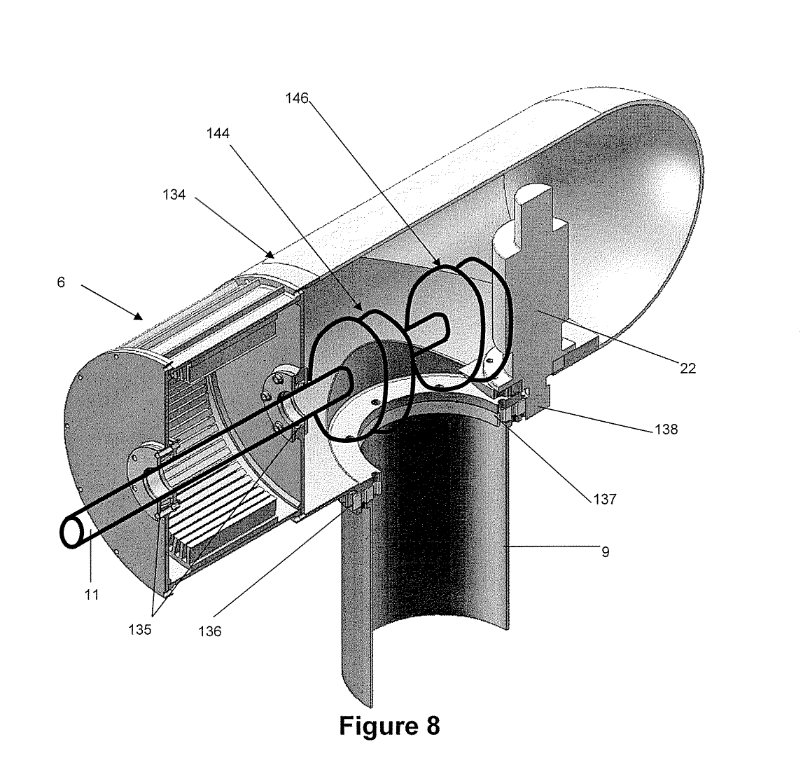

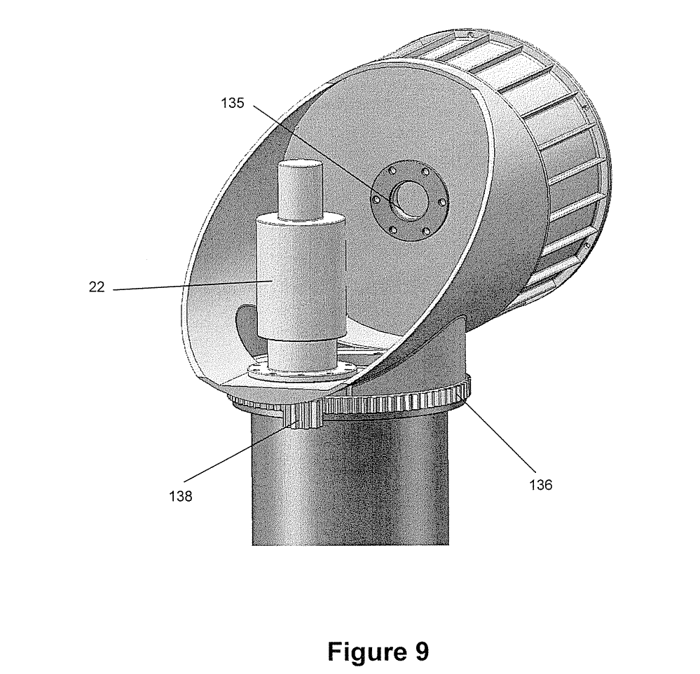

The wind turbine 8 includes a mast 9 that supports a windmill assembly 10 and generates electricity through an internally housed electrical generator 6. The windmill assembly 10 includes a rotor, whereby the rotor has one or more aerodynamic surfaces or blades 4. The rotor is mounted on a shaft 11 to rotate about a horizontal axis as wind 2 passes over the blades 4. As can best be seen in FIGS. 7 to 9, the generator 6 is housed in a nacelle 134 that is mounted to the top of the mast 9 and supports the shaft 11 in bearings 135. The shaft 11 is connected to a rotor of the generator 6, that rotates within a stator assembly mounted in the nacelle 134 and thereby generates electrical power. The generator 6 is typically a multiple pole or alternating current (AC) machine that generates power across three phases. The frequency of the AC power produced is proportional to the rotational speed of the generator. Although a horizontal axis wind turbine 8 is shown, it can be appreciated that some of the principles described herein are also applicable to vertical axis wind turbines.

The nacelle 134 is connected to the mast 9 by a yawing mechanism to permit the nacelle 134 to be rotated about a vertical axis to turn the windmill assembly 10 in to the wind. The yawing mechanism includes a stationary ring gear 136 is supported by a mast 9 and a bearing 137 to connect the mast 9 and nacelle 134. A yaw motor 22 mounted in the nacelle 134 includes a spur gear 138, that engages the stationary ring gear 136 so that operation of the yaw motor 22 rotates of the gear 138 and causes the nacelle 134 to rotate about a vertical axis, i.e. to yaw.

The shaft 11 extends through the nacelle 134 and carries a pair of normally closed brake assemblies 144, 146 that act on the shaft 11 to inhibit rotation. Each of the brakes 144, 146 are released by a respective actuator under control of the controller 12 to brake the windmill assembly 10 under certain conditions.

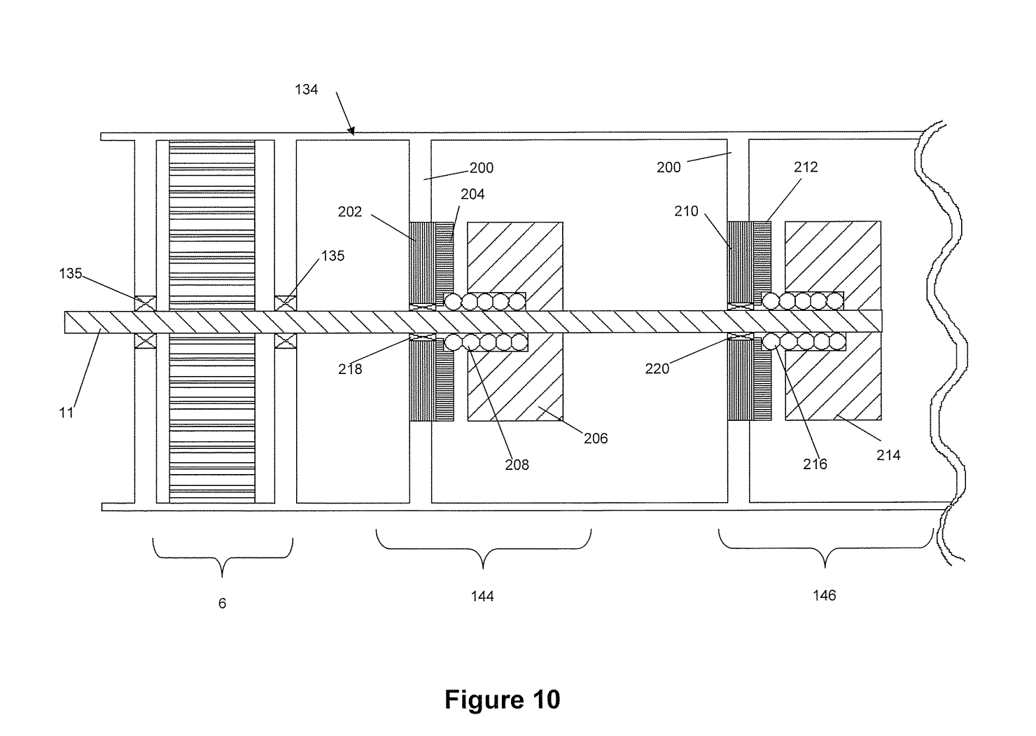

Referring to FIG. 10, the normally closed brakes 144, 146 can best be seen. The shaft 11 extends through the generator 6, and then through the first and second normally closed brakes 144, 146. In the first normally closed brake 144, a first stator 202 is concentrically fixed in place around the shaft 11.

The first stator 202 is held stationary with struts 200 extending inwardly from the nacelle 134. Bearings 218 concentric with the first stator 202 and shaft 11 rotatably support the shaft 11. A first braking plate 204 is splined with the shaft 11. The key spline connects the first braking plate 204 to the shaft 11 while allowing the first braking plate 204 to axially slide along the shaft 11. A first coil 206 is disposed concentrically on the shaft 11 and is both axially and rotatably fixed relative to the shaft 11. Thus, when the shaft 11 rotates, the first coil 206 also rotates. An annular space within the first coil 206 houses a first biasing element or compression spring 208, which biases the first braking plate 204 away from the first coil 208 and towards the first stator 202. In the normally closed position, as shown in FIG. 10, the spring 208 biases the first braking plate 204 into frictional or mechanical engagement with the first stator 202. Thus, in a closed position, the rotation of the first braking plate 204 is prevented or decreased and, in turn, prevents or decreases rotation of the shaft 11. In an open position, not shown here, current is passed through the first coil 206, thereby generating an electromagnetic force to move the first braking plate away from the first stator 202 and towards first coil 206. It can be appreciated that the electromagnetic force is sufficient to overcome the biasing force of the spring 208. Thus, in an open position, the first braking plate 204 and the shaft 11 can freely rotate. Allowing the shaft 11 to rotate freely in turn allows the blades 4 to rotate freely.

Preferably, a second normally closed brake 146 is disposed further along the shaft 11. The second normally closed brake 146 advantageously increases the braking force and increases the redundancy, should one brake become inoperable. In FIG. 10, the second normally closed brake 146 has the same components and configuration as the first normally closed brake. In particular, it comprises a second stator 210, bearing 220, second braking plate 212, second biasing element or spring 216 and second coil 214.

It can be appreciated that there well known variations of the mechanical and electrical configurations for the braking mechanisms, including normally closed braking mechanisms, are applicable to the principles described herein. Other braking mechanisms, for example disk brakes with callipers, may be used.

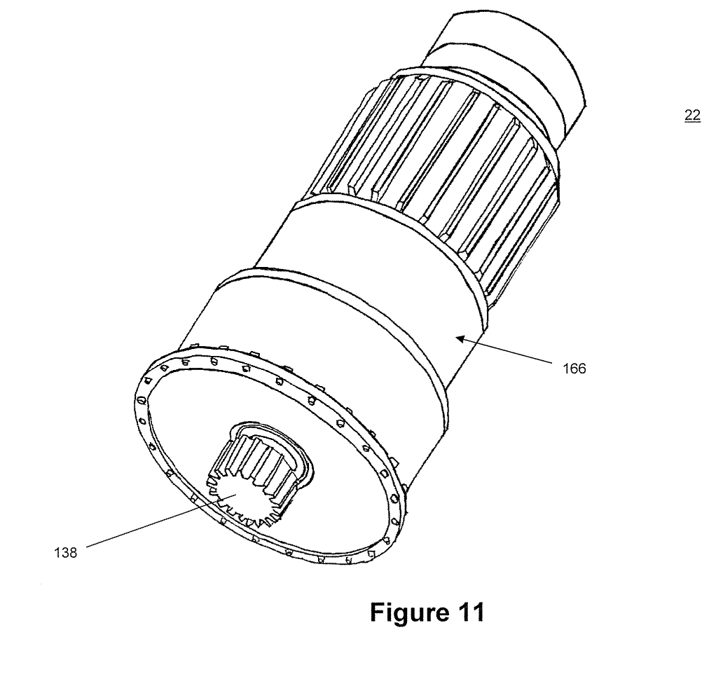

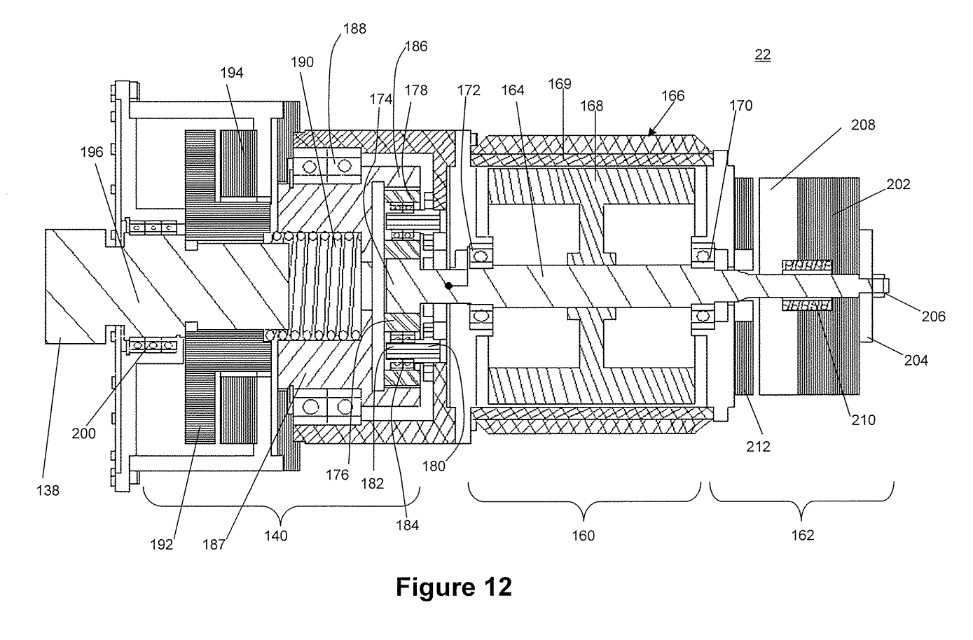

Referring to FIG. 11, the yaw motor assembly 22 includes a housing 166. As can be best seen in FIG. 12, the yaw motor assembly 22 comprises a yaw motor 160, normally open yaw clutch 140 and normally closed brake 162. In the embodiment shown, the yaw motor 160 is located between the normally open yaw clutch 140 and the normally closed yaw brake 162. The yaw motor 160 includes a motor shaft 164 that is supported by bearings 170, 172 located at opposite ends of the yaw motor 160. The yaw motor 160 also includes a stator 169 and a rotor 168. The rotor 168 is fixed to the motor shaft 164. One end of the motor shaft 164 extends into a planetary gearing system, which is connected to the normally open yaw clutch 140. The motor shaft 164 is connected to a sun gear 174, such that rotation of the motor shaft 164 causes the sun gear 174 to rotate as well. The teeth of the sun gear 174 mechanically engage the teeth of planet gears 176, 178. The planet gears 176, 178 rotate on bearings 184 cammed by each stationary shaft 182. Each stationary shaft 182 protrudes from a stationary carrier 180 that is fixed to the housing 166. The teeth of the planet gears 176, 178 mechanically engage the inward protruding teeth of a ring gear 186. It can thus be appreciated that rotation of the motor shaft 164 causes the planet gears 176, 178 to rotate, and the rotation of the planet gears 176, 178 causes the ring gear 186 to rotate.

The ring gear 186 is connected to a driven plate of the clutch 187, such that rotation of the ring gear 186 causes the driven plate of the clutch 187 to rotate as well. Bearings 188 rotatably support the driven plate of the clutch 187 within the housing 166. An annular cavity defined axially within the driven plate of the clutch 187 partially or completely holds a biasing element or compression spring 190, which engages and biases a drive plate of the clutch 192 away from the driven plate of the clutch 187. The drive plate of the clutch 192 is concentric with a spur gear shaft 196 and, in particular, the drive plate of the clutch 192 has an annular space in which the spur gear shaft 196 passes through. The spur gear shaft 196 and drive plate of the clutch 192 are splined to one another, so that they rotate together the two parts, while allowing the drive plate of the clutch 192 to axially slide along the spur gear shaft 196. An annular coil 194, also concentric with the spur gear shaft 196, is positioned between the drive plate of the clutch 192 and the driven plate of the clutch 187. Without current in the coil 194, as shown in FIG. 12, the clutch 140 is in the normally open position. The biasing element or spring 190 biases the drive plate of the clutch 192 away from the driven plate of the clutch 187. When current is passed through the annular coil, the normally open yaw clutch 140 moves into a closed position, not shown, by the drive plate of the clutch 192 axially sliding along the spur gear shaft 196 towards the annular coil 194. In the closed position, the face of the drive plate of the clutch 192 frictionally or mechanically engages the annular coil 194 and the driven plate of the clutch 187. Thus, in the closed position, rotation of the driven plate of the clutch 187 causes the drive plate of the clutch 192 to also rotate. In turn, the rotation of the drive plate of the clutch 192 causes the spur gear 138 to rotate. It can thus be appreciated that when the annular coil 194 is energized, whereby the yaw clutch 140 is in a closed position, activation of the yaw motor 160 causes the spur gear 138 to rotate. Conversely, when the yaw clutch 140 is in its normally open position, even when the yaw motor 160 is activated, no torque is transferred from the yaw motor 160 to the spur gear 138. Thus, when the yaw clutch 140 is in a normally open position, the nacelle 134 is free to rotate or yaw about the mast 9 and mast bearings 137. It can also be understood that other mechanisms for biasing the yaw clutch 140 to an open position and closing the yaw clutch 140 when given a command are equally applicable to the principles herein.

The normally closed yaw brake 162 engages the other end of the motor shaft 164. As can be seen, the motor shaft 164 extends axially through a stator plate 212. A brake plate 208 is keyed to the motor shaft 164, with a solenoid 202 located between the brake plate 208 and an end plate 204. The stator plate 212 is stationary and fixed to the yaw assembly's housing 166. The brake plate 208 rotates with the motor shaft 164 and is allowed to axially slide along the motor shaft 164. The solenoid 202, end plate 204 and bolt 206 are fixed to the motor shaft 164. A compression spring 210 is located between the end plate 204 and the brake plate 208. The compression spring 210 biases the brake plate 208 away from the solenoid 202 and towards the stator plate 212. In the normally closed position, not shown here, the brake plate 208 frictionally or mechanically engages the stator plate 212, thereby slowing or stopping the brake plate 208 and, thus, motor shaft 164 from rotating. In the open position, shown in FIG. 12, when a current is passed through the solenoid 202, the brake plate 208 is pulled away from the stator plate 212 by overcoming the biasing of the spring 210. Thus, in an open position, the brake plate 208 and motor shaft 164 are free to rotate.

It can be appreciated that the mechanical and electrical configurations for the brakes described herein are for example, and that well known variations of biased brakes (e.g. normally closed or normally open) may be used.

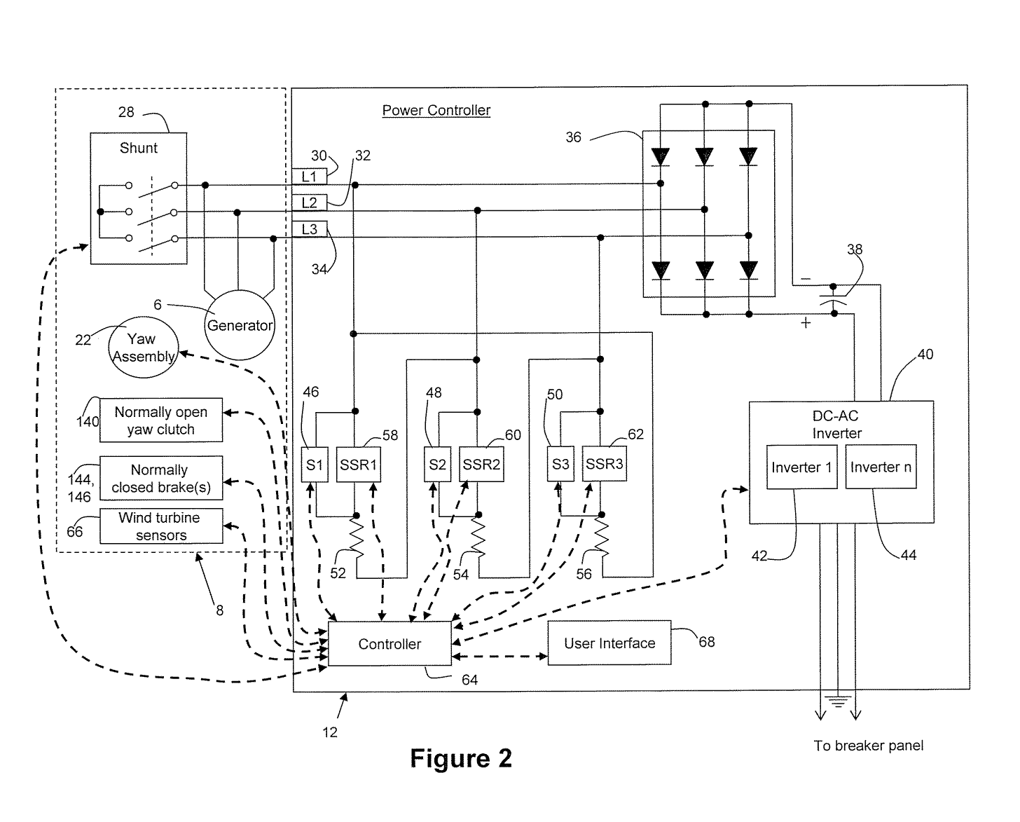

Turning to FIG. 2, the power controller 12 employs a number of different control strategies to regulate the power output and operation of the wind turbine 8. The generator 6 generates a phase shifted sinusoidal voltage on each of the three phase lines, marked L1 (30), L2 (32) and L3 (34). A shunt switch 28 is connected in parallel to the power controller 12 that, in a closed position, that can electrically connect all three phase lines 30, 32, 34 together to create an electrical short. Each of the phase lines 30, 32, 34 is connected to a bridge rectifier 36 housed within the power controller 12. The power generated by the turbine on each of the phase lines 30, 32, 34 is in AC form and is converted and combined by the bridge rectifier 36 into direct current (DC) voltage. A capacitor 38 is positioned at the output of the bridge rectifier 36 to filter or smooth disturbances in the voltage signal. The filtered DC voltage signal is then electrically transmitted to a DC-AC inverter 40. The inverter 40 converts the DC power to AC power at a power rating that is operable for the utility breaker panel 14. In North America, for example, the power rating is nominally 120V for smaller appliances and 240V for larger appliances, in both cases operating at a frequency of 60 Hz. The inverter 40 may also comprise a plurality of inverters 42, 44 for redundancy and increased current output. For example, if inverted (42) fails, then backup inverter N (44) is still operable and is able to continue outputting AC power to the utility breaker panel 14.

Each phase line 30, 32, 34 is electrically connected to an input of a solid state relay switch (SSR) 58, 60, and 62. In particular, phase line L1 (30) is electrically connected to SSR1 (58); phase line L2 (32) is electrically connected to SSR2 (60); and phase line L3 (34) is electrically connected to SSR3 (62). The output of each SSR is also electrically connected through a resistor 52, 54, 56 to the input of a SSR associated with another phase line. In particular, resistor R1 (52) is electrically connected between the output of SSR1 (58) and the input of SSR2 (60); resistor R2 (54) is electrically connected between the output of SSR2 (60) and the input of SSR3 (62); and, the third resistor R3 (56) is electrically connected to the output of SSR3 (62) and the input of SSR1 (58).

Electrically connected in parallel with each SSR is a normally closed switch, indicated as switch S1 (46), in parallel to SSR1 (58); switch S2 (48) in parallel to SSR2 (60); and switch S3 (50) in parallel to SSR3 (62), respectively.

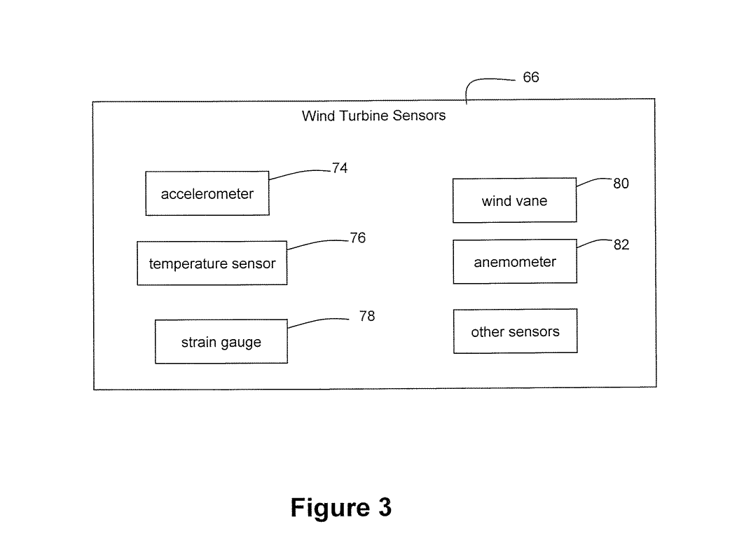

The switchers S1, S2, S3 are controlled by a controller 64 which also controls operation of the yaw clutch 140, brakes 144, 146 and yaw motor 22 as indicated by chain dot lines. Sensors 66 are incorporated to measure various aspects of the wind turbine's functions and external environment and provide inputs to a controller 64. As illustrated in FIG. 3, sensors 66 include an accelerometer 74 to measure vibrations and movement in the wind turbine 8. A temperature sensor 76 measures the temperature of various components in the wind turbine 8, such as the electrical windings in the turbine 6. A strain gauge 78 measures the mechanical strain of the certain structural components of the wind turbine 8. A wind vane 80 measures the direction in which the wind is blowing. An anemometer 82 measures the speed of the wind. It can be appreciated that other sensors for measuring various aspects of the wind turbine's functions and external environment are equally applicable to the principles herein. The information provided by one or more of these sensors 66 may be used by the controller 64 to implement one or more control strategies to control the turbine 8 as will be discussed more fully below.

The controller 64 is housed in power controller 12 and operates to monitor and control the functionality of the wind turbine 8. In the embodiment shown, the controller 64 controls the operation of the inverter 40, SSRs 58, 60, 62, normally closed switches 46, 48, 50, yaw motor 22, shunt switch 28, normally open yaw clutch 140 and normally closed brake(s) 144, 146. The controller 64 can also monitor the power and frequency in each of the phase lines 30, 32, 34 and monitor the operation of the inverter 40. The controller 64 also monitors the information provided by the sensors 66. It can be appreciated that the controller 64 can be located in other locations ancillary to the power controller 12 while still controlling various aspects of the wind turbine 8. The controller 64 is any electrical device that is capable of executing computer instructions and may comprise either one or combinations of a processor, microprocessor, memory, communication interfaces, etc. Interaction with the controller 64 is provided by a user interface 68. The user interface 68 may comprise a display screen, keyboard, mouse, etc. The above components and their respective functionality are explained in more detail below.

The inverter 40 includes a maximum power point tracking (MPPT) feature to increase the power output by operating at a voltage reference optimised for the generator 6. The MPPT calculates the voltage reference at which the generator 6 is able to produce maximum power based on a predetermined current v.s. voltage (or power) curve. Different wind turbines have different power curves, and this different optimal power settings. The inverter 40 then establishes the current drawn whilst maintaining the calculated voltage reference. The MPPT feature is used to control the RPM of the wind turbine 8. By varying the current drawn for the selected voltage, the torque imposed on the shafts 11 may be varied and the rotational speed controlled.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the power controller 12, controller 64, user interface 68, etc., or accessible or connectable thereto. Any application or module herein described may be implemented using computer readable/executable instructions that may be stored or otherwise held by such computer readable media.

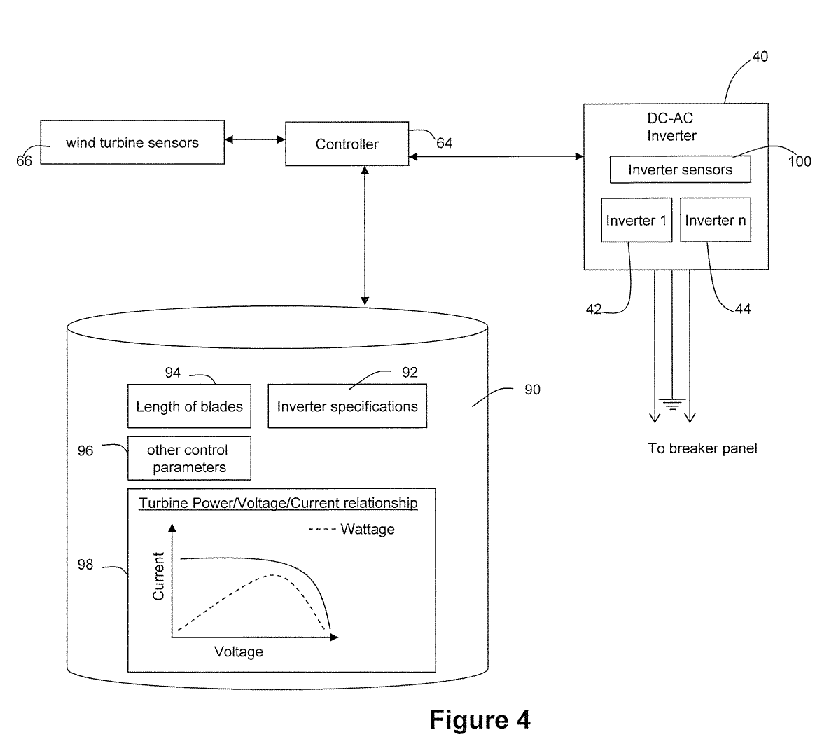

Referring to FIG. 4, the inverter 40 is in electrical and data communication with the controller 64. The inverter 40 includes inverter sensors 100 which measure the voltage, current, frequency, temperature, of various electrical components in the inverter 40. Inverter components include for example, a MOSFET, a diode and a transformer. Data from the inverter sensors 100 is transmitted to the controller 64. The controller 64 also receives data from the wind turbine sensors 66. To determine whether inverter 40 should draw more current, the controller 64 also considers a number of factors that are stored in the database 90. The turbine's power/voltage/current relationship 98 is considered in order to maximize the power output. The relationship 98 is stored in a database 90, in one of several forms, including a mathematical formula or a look-up table comprising numerous data entries. As noted, each wind turbine 9 may have a different relationship 98 characterizing its power performance. The controller 64 may also consider other factors when using the inverter 40 to draw more current. These factors include the length of the blades 94, which is used to determine the speed of the blade tips and limit the speed to the mechanical and aerodynamic constraints of the blades. Yet another set of factors is the inverter specifications 92. For example, various electrical components in the inverter 40 may have operational limits in terms of voltage, current and temperature. It may be desirable to operate within the nominal specifications of the components. There may also be other control parameters 96 that can be entered into the database 90 by a user.

As noted above, the controller 64 may be used to implement a number of different control strategies, either individually or in combination. The primary control strategy utilises the inverter 40 to control the generator speed. The controller 64 uses the measured frequency of the phase lines 30, 32, 34 to calculate the RPM of the turbine 6. The controller 64 then uses the RPM to determine the angular velocity of a blade. When taking into account the length of the blade 94 and the angular velocity, the controller 64 can then determine the blade's tip speed. In the case where the tip speed is too high, the controller 64 may wish to command the inverter 40 to draw more current, thereby reducing the RPM and the blade's tip speed. However, the controller 64 may also take into account the power/voltage/current relationship 98 to maintain an optimal wattage or power output. For example, as shown increasing the current draw of the inverter 40 to only reduce the tip speed may reduce the power output of the inverter 40. To avoid this, the controller 64 may also consider the relationship 98 to increase the current draw while maintaining power output.

The controller 64 also operates to inhibit saturating of the inverters by increasing the inverter's current draw. The saturation of the inverter 40 relates to the upper operating limits of the inverter's electrical components. For example, components in the inverter 40 may have a maximum rating of 600 V. This information is stored in the inverter specifications 92 and is used by the controller 64 in combination with the measured data from the inverter sensors 100 to control the current draw and thereby the RPM of the turbine 6. For example, if the measured input voltage from the inverter sensors 100 is approaching 600V, which is the upper voltage limit of the component in the inverter 40, the controller 64 will increase the current draw in the inverter 40, thereby decreasing the RPM of the turbine 6. Decreasing the RPM in the turbine 6 in turn decreases the voltage produced.

Under normal operating conditions, the controller 64 is able to control the rotational speed of the generator 6 through adjustment of the inverters 40. However, situations may arise where further loading is required than is available from the inverter 40. In this event, the SSRs 58, 60, 62 are used to control the flow of electricity through the resistors 52, 54, 56. Referring back to FIG. 2, the SSRs 58, 60, 62 are normally in an open state to prevent the flow of electricity through the resistors 52, 54, 56. The controller 64 is connected to each of the SSRs 58, 60, 62 and is able close the relays, thereby allowing the flow of electricity through the corresponding resistors. The controller 64 can control each SSR individually. For example, when the controller closes only SSR2 (60), electricity flows from L2 (32) through R2 (54) and then to L3 (34). Thus, the resistive load between L2 (32) and L3 (34) increases, which in turn increases the load and decreases the RPM of the turbine 6. Decreasing the RPM reduces the voltage, frequency and power output of the wind turbine 8. The controller 64 therefore can selectively activate one or more SSRs 58, 60, 62 to reduce the RPM, voltage, frequency and power output of the wind turbine 8. It is preferable that the resistors 52, 54, 56 have a sufficient resistance value to create enough load to stop the wind turbine's blades 4 from rotating. However, other resistance values are equally applicable to the principles herein. In one example, where the generator 6 can generate 10 KW of power and up to 600VAC across three phases, the resistors 52, 54, 56 are each rated for 15 KW and have a resistance value of 4 Ohms.

The activation or firing of the SSRs 58, 60, 62 can be timed to decrease the RPM in a controlled manner. The SSRs 58, 60, 62 are activated or fired for a certain interval for each half-cycle of the respective phase lines (e.g. one half-cycle is positive voltage and the other half-cycle is negative voltage). When the SSRs 58, 60, 62 are activated, the current through the respective resistors 52, 54, 56 increases the electrical load the in the respective phase lines 30, 32, 34 for the period that the SSR's are activated. Because the wind is constantly varying, the firing of the SSR's requires the intervention of the controller 64.

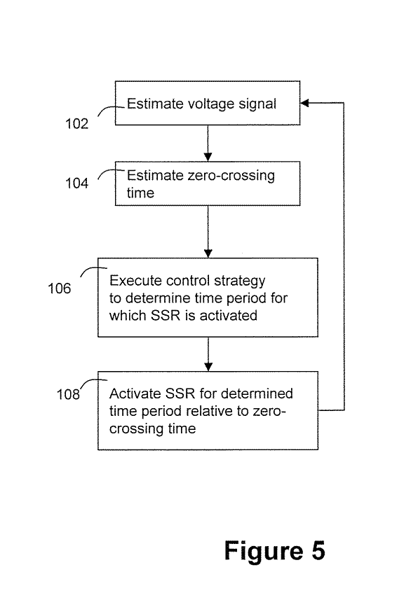

Turning to FIG. 5, a method of selectively activating the SSRs 58, 60, 62 to chop-up the voltage is shown. Each phase line is monitored independently. As step 102, the voltage signal on a phase line is estimated by sampling the voltage signal at a high frequency. In one embodiment of the estimation method, there are over 400 sample points through each cycle of the voltage waveform. As the waveform is sampled, it first passes through a 15-point “median filter”, which is a type of digital filter to reduce or eliminate high-energy impulse noise of up to 7 points (samples) wide. The median filter advantageously removes impulses up to half of it's sample points thereby preventing undesirable portions of that impulse from carrying forward into the output.

Following the output of the median filter is a 4-point accumulation filter, which although preferably implemented digitally, approximates a traditional analog RC filter. Its purpose is to smooth out larger variations in the waveform.

Continuing with FIG. 5, after estimating the voltage signal in step 102, additional filter is used to estimate the zero-crossing at step 104. The double-filtered stream of samples is compared against a +/− voltage threshold to provide hysteresis in the detection of zero-crossings. For example, a voltage threshold well within a 600VAC turbine is +/−25V. Thus, a zero-crossing is only determined if the filtered signal goes from >+25 v to <−25 v or vice-versa. It can be appreciated that zero-crossings within this voltage threshold (caused by residual noise) are not considered to be zero-crossings.

Zero-crossings and peak voltages are tracked for each of the three phase lines coming from the generator 6, and the period of each half cycle is measured at each zero-crossing. Rotational speed (as measured using frequency) is calculated as the inverse of the longest period measured among the three phases. By using the inverse of the longest period amongst the three phases, a large noise causing a zero-crossing as recorded in one or more phase lines will not affect the final frequency determination. The estimation can be further made more consistent by filtering the peak voltage differences between the phases, wherein the differences are filtered with a weighted accumulation filter. In one embodiment, if the peak voltage differences between the phase lines exceed a predetermined maximum, then the controller 64 will shutdown the turbine 6 to avoid malfunction.

Continuing with FIG. 5, upon estimating the zero-crossing in step 104, the controller 64 performs computer executable instructions to determine the time period for which one or more SSRs should be activated, as per step 106. The control strategy for determining when the SSRs should be activated considers various factors including the zero-crossing time, the peak-to-peak voltage, the frequency, and user determined thresholds and set points. Other considerations in the control strategy include RPM limits, vibration or noise in the wind turbine housing 8, mechanical stress in the wind turbine 8, and tip speed of the blades 4. These factors are combined in accordance with a selected control algorithm to determine the period that the SSR's are activated. It can be appreciated that a number of control strategies are applicable to the principles herein and that the algorithm may combine the inputs linearly (etc).

At step 108, the controller 64 activates one or more SSRs for the time period as determined in step 106. The activation of the SSR is executed relative to a zero-crossing (e.g. either a time period before or after a zero-crossing). When a SSR is activated, the corresponding resistor draws current thereby increasing the load in the generator 6 during the determined time period. This decreases the rotation speed or RPM of the generator 6, thereby decreasing the frequency and voltage. As shown in FIG. 5, the change in frequency and voltage requires the voltage signal and zero-crossing to be estimated again as per steps 102 and 104, respectively. It can thus be seen that the method of initiating the increased electrical load on a phase line is iterative.

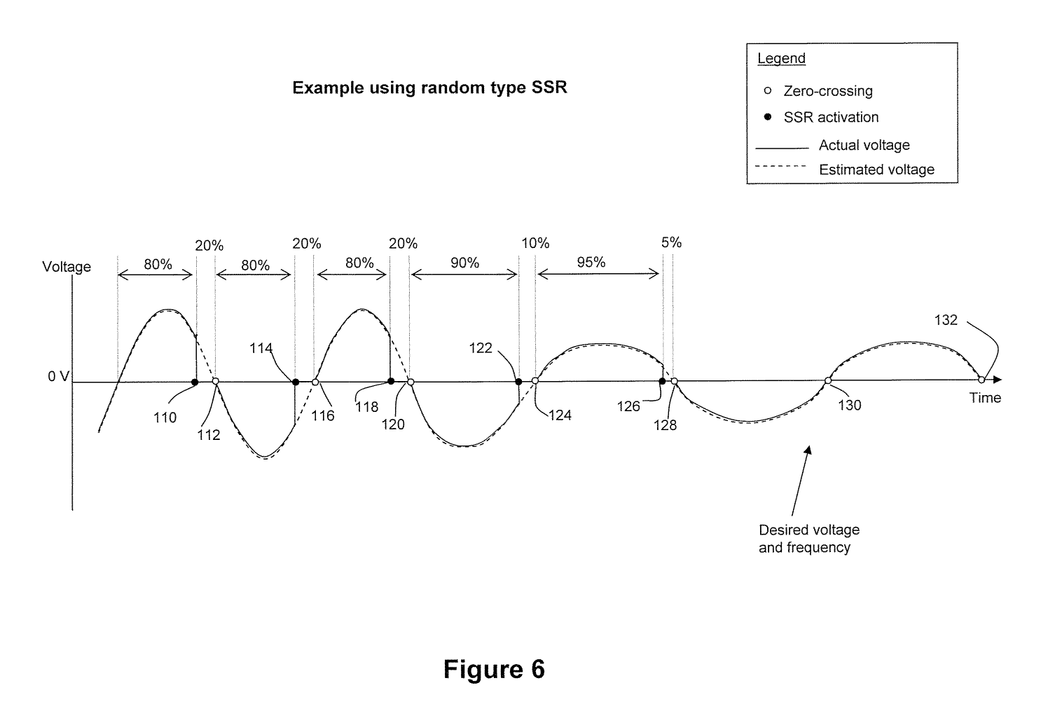

Turing to FIG. 6, an example of a voltage signal on a phase line is provided, wherein the SSR is a random type. The estimated voltage signal is shown in a dotted line and the actual voltage signal is shown in a solid line. The estimated zero-crossings are represented with a unfilled circle and the points in time at which the random type SSR is activated are represented with a solid filled circle. A random type SSR is configured to remain closed, once activated, until a zero-crossing occurs. In other words, the random type SSR returns to its normally open state once a zero-crossing occurs. In FIG. 6, the controller 64 has determined that the SSR should be activated for 20% of the time period of a half cycle because the voltage and frequency are too high. Thus, the SSR is activated at the point in time 110 before the zero-crossing 112. Between the time the SSR is activated 110 and the zero-crossing 112, the electrical load in the phase line increases due to the resistor. The same process is continued for the following two subsequent half cycles, wherein the SSR is activated at point 114 and deactivated at point 116, and then activated at point 118 and deactivated at 120. It can be seen that the SSR is deactivated at the zero-crossing because it is a random type.

With successive application of the SSR's, the turbine 6 begins to slow down because of the increased electrical load. As can be seen, the voltage signal begins to decrease in amplitude and frequency and the controller 64 will reduce the activation of the SSR to 10% of the time of the half cycle, as shown by the activation at point 122 and deactivation at point 124. Similarly, according to the example control scheme shown here, the further reduced amplitude and frequency of the voltage will accordingly also further reduce the activation of the SSR to 5% of the time of the half cycle, as shown by activation point 126 and zero-crossing point 128. Upon the estimated voltage waveform reaching a desired amplitude and frequency, the controller 64 stops chopping or pulsing the waveform. In the example, the time period between the zero-crossings 128, 130, and 132 have reached a steady state.

It can be appreciated that various other types of SSRs or switches are applicable and that other methods of estimating the voltage signal and zero-crossings are encompassed within the scope of the power controller 12.

In one control strategy, the controller 64 may activate the SSRs according to saturation thresholds of the inverter 40. In other words, as the inverter 40 nears or enters saturation, the controller would begin activating the SSR's to reduce the RPM and the voltage output of the generator 6. It is sometimes desirable that the controller 64 and SSRs act to keep the inverter 40 saturated as much as possible without allowing the voltage to significantly exceed the threshold, while ensuring the voltage is not less than the threshold. This in turn would increase power output and avoid over saturating the inverters. In another control strategy, the intermittent activation of the SSRs and resistors is used in combination with the MPPT feature of the inverter 40. The controller 64 calculates a range of optimal power production using the power/voltage/current relationship 98 and from the calculated range of optimal power production, activates one or more SSRs and commands the inverter 40 to draw more current. The combined load of the SSR's and increased current draw from the inverter 40 is used to regulate the power output of the generator 6.

The selective operation of the SSR's is advantageous for adapting to wind gusts that quickly speed up the turbine for short periods of time. However, where a prolonged increase in wind velocity occurs an alternative control strategy is beneficial.

In another aspect of the power control 12, a sustained approach is used to decrease the RPM of the wind turbine 8. Instead of over producing electrical energy and dissipating the same as heat through resistors, the controller 64 intervenes to yaw the wind turbine 8 out of the direction in which the wind is blowing. By facing the wind turbine 8 in a direction partially out of the wind, the aerodynamic efficiency is decreased and the turbine's RPM decreases. The direction of the wind is measured by a wind vane 80, with which the controller 64 communicates. Based on the feedback from the wind vane measurements and other sensor measurements, the controller 64 sends a control signal to the yaw motor 22 to turn the blades away from the wind. It can be appreciated that yawing the wind turbine 8 out of the wind would avoid solely relying on the resistors and advantageously reduce dissipating the generated electrical energy into heat.

In general, the controller 64 will position the yaw angle of the wind turbine 8 to regulate the RPM or speed of the blades. In one embodiment, the RPM of blades is maximized, for a given wind speed, when the wind turbine 8 is yawed into a certain direction relative to the direction that the wind is blowing, e.g. the yaw angle of the nacelle 134 can be ±α° relative to the wind direction while still maintaining a power output. When it is desirable to reduce, or prevent further increase in, the RPM, the nacelle 134 can be yawed at a different angle relative to the wind direction so that the aerodynamic efficiency of the blades is reduced, and the torque generated on the blades is reduced so that they spin at slower speeds. For example, in certain wind turbine designs, when the nacelle 134 has a yaw angle of +15° away from the oncoming direction of the wind or −15° away from the oncoming direction of the wind, the RPM is highest for the given wind speed. Continuing with the example, changing the yaw angle of the nacelle 134 to +20° or −20° away from the oncoming wind will reduce torque output and maintain the RPM at the required level. It can be appreciated that the relationship between the wind turbine's RPM, the wind turbine's yaw angle relative to the wind direction, and wind speed is likely dependent on the design of the wind turbine 8. However, generally, the wind turbine's yaw angle relative to the wind direction can be changed to regulate the RPM of the wind turbine 8. This is particularly useful when the pitch of the blades is fixed, as is typical in lower power output wind turbines. Yawing the wind turbine 8 to reduce the torque output on the blades also reduces the heat generated from dissipating excess power through resistors.

The timing and the angle of yawing is dependent on various factors. The controller 64 yaws the facing direction of the wind turbine 8 when there are prolonged high speed winds that cause the RPM to go over a certain limit and cause the inverters to become over saturated. In its simplest form, the voltage in each of the phase lines is monitored and as continued saturation occurs the controller 64 initiates operation of the yaw motor 22. The reduction in efficiency causes a corresponding decrease in voltage. To determine such conditions, the controller 64 receives wind speed measurements from the anemometer 82 or other wind speed measurement sensors. It can be appreciated that wind speed sensors may be placed in various locations around or in the vicinity of the wind turbine 10 to more accurately measure the wind speed. Other considerations include the temperature of the windings in the generator 6, as measured using one or more temperature sensors 76. Moreover, oscillations in the wind turbine 8, as measured by on or more accelerometers 74, can be used to indicate unsteady winds and excessively high wind speeds. The RPM and inverter saturation may also be considered and are monitored by measuring the voltage lines into the inverter 40. Varying the angle of yaw may address any one or combination of these factors. The angle of yaw may also address user commands provided through the user interface 68. One exemplary control strategy may be to reduce the efficiency and thus, produce less power during low demand periods. It can be appreciated that a number of factors may be considered to determine when and by how much the wind turbine 8 should yaw in order to reduce the RPM.

In the event of power failure, or more particularly failure of the controller 64, it is desirable to prevent the blades of the wind turbine 8 from rotating too fast in an uncontrolled manner. Thus, turning back to FIG. 2, another aspect of the power controller 12 is used to slow down or stop the blades 4 from rotating when power is lost. The normally closed switches 46, 48, 50 are used to pass current through each of the respective resistors 52, 54, 56, thereby generating sufficient load to slow down or stop the generator 6 and, thus, the blades 4 from spinning. It is noted that the switches 46, 48, 50 in normal operation are constantly activated to an open position by the controller 64, such that current does not flow through the resistors 52, 54, 56. However, when the controller 64 fails, for example due to power failure, then the controller 64 is no longer able to activate the switches 46, 48, 50. Thus, the switches 46, 48, 50 return to their normally closed state, thereby circumventing the SSRs 58, 60, 62.

As a further safeguard, should the controller 64 fail, in the nacelle 134, the normally closed brakes 144, 146 return to their closed state, thus generating load on the generator 6. In normal operation, the controller 64 commands one or both of the normally closed brakes 144, 146 to be open. When both brakes 144, 146 are open, the blades 4 are allowed to rotate freely. Upon failure of the controller 64, the normally closed brakes 144, 146 are no longer held open by the controller 64 and thus, return to the closed state. This prevents the blades 4 from rotating freely.

To further protect the operation of the generator 6, the normally open yaw clutch 140 located between the drive motor 160 and spur gear 138 returns to an open state when the controller 64 fails. In normal operation, the controller 64 commands the normally open yaw clutch 140 to be closed, thus, restricting yawing motion between the gear 138 and ring gear 136. Upon failure of the controller 64, the normally open yaw clutch 140 is no longer activated by the controller 64 and thus, returns to its open state and allows the nacelle 134 to rotate to place the blades downwind.

It will be understood that, under normal operating conditions, for example, when the yaw clutch 140 is in a closed position, the normally closed yaw brake 162 advantageously prevents or reduces inadvertent yawing of the nacelle 134. When the nacelle 134 is to be yawed in a controlled manner, the yaw brake 162 is energized into an open position. Thus, the yaw brake 162 advantageously only requires power when yawing the nacelle 134.

It can also be appreciated that when power is lost, the normally open yaw clutch 140 allows the spur gear 138 and, thus the nacelle 134, to yaw freely in an uncontrolled manner down wind. Based on the aerodynamic profile of the wind turbine 8 and blades 4, the wind turbine 8 will be pushed by the wind to face downwind. When the nacelle 134 and blades 4 are facing the downwind direction, the wind hits the back of the blades 4. Since the back surface of the blades are substantially flat, there are little to no aerodynamic forces that will cause the blades 4 to spin, even in windy conditions. Thus, by disengaging or opening the yaw clutch 140, the nacelle 134 naturally yaws to a downwind direction, whereby the blades 4 do not spin in the absence of sufficient aerodynamic forces.

Turning back to FIG. 2, a shunt switch 28 can be closed to connect all phase lines 30, 32, 34 together, thereby creating an electrical short in the generator 6. When the shunt switch 28 is closed, load is generated in the generator 6 and thus, slows down or stops the rotor in the generator 6 from rotating. The shunt switch 28 can either be controlled by the controller 64 or manually operated. The shunt switch 28 may also be normally closed, such that, when the controller 64 fails, the shunt switch 28 returns to its closed state. In another embodiment, the shunt switch 28 may be controlled by a mechanical lever located at the base of the wind turbine 8 to allow a user to electrically short the turbine. Shorting the generator 6 prevents electricity from being generated.

It can be appreciated that various control mechanisms (e.g. current draw from inverter 40, selective operation of the SSRs, yaw motor 22, normally closed switches, normally closed brakes 144, 146, normally open yaw clutch 140, and shunt 28) may be employed simultaneously or in serial to control the RPM of the wind turbine 8. Moreover, each of the control mechanisms may be employed independently based on various control strategies.

It can be appreciated that the normally closed switches 46, 48, 50 may also be closed in a controlled manner under the command of the controller 64. Similarly the normally open yaw clutch 140 and normally closed brakes 144, 146 may also be used to slow down or stop blades 4 from rotating as per the commands of the controller 64.

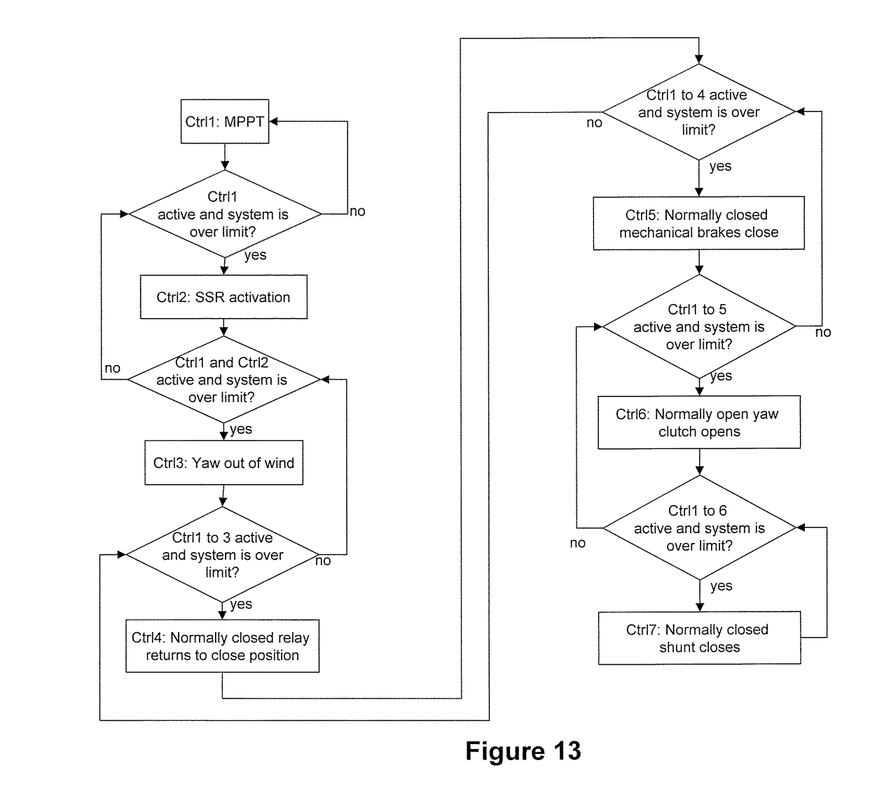

An example control method for the serial operation of the control mechanisms is shown in FIG. 13. In the example method, the control mechanisms are employed in series, wherein the MPPT feature of the inverter 40 is employed first. If a power threshold or RPM threshold is exceeded since, for example, the active control mechanisms alone are insufficient to reduce the RPM, then the next control mechanism is employed in addition to the previous control mechanism. In the embodiment shown in FIG. 13, the selective operation of the SSR's is employed in simultaneous operation with the MPPT if the threshold is still exceeded. Thereafter, if a prolonged period of operation of the SSR's is observed, or if inverters and SSRs are insufficient to reduce the RPM, then the controller 64 operates the yaw assembly 22 to decrease the efficiency of the blades 4. If the inverters, SSRs and yawing is insufficient to reduce the RPM, then the normally closed switches 46, 48, 50 close to activate the resistors. If the previous combination of control mechanisms do not sufficiently reduce the RPM, then one or more of the normally closed mechanical brakes 144,146, close. If this combination including the normally closed mechanical brakes are insufficient to reduce the RPM as desired, then the normally open yaw clutch 140 opens. If the combination including the normally open yaw clutch is insufficient to reduce the RPM as desired, then the shunt switch 28 is employed.

It can be appreciated that the control strategies used to employ the described control mechanism can be configured by the user. The user may be able to configure the control strategies using the user interface 64, which is in communication with the controller 64. For example, any one of the above control mechanisms or combinations thereof, may be configured to activate according to various thresholds as configured by the user.

Although the above has been described with reference to certain specific embodiments, various modifications thereof will be apparent to those skilled in the art as outlined in the appended claims.

1. A method for controlling the rotation speed of a rotor having one or more blades on a wind turbine comprising:
determining the yaw angle of the wind turbine relative to the wind direction; and
changing the yaw angle of the wind turbine to increase or decrease the aerodynamic efficiency of the rotor and, thus, controlling the rotation speed of the one or more blades.

2. The method of claim 1 wherein a controller sends a command to the yaw motor, and the yaw motor changes the yaw angle of the wind turbine.

3. The method of claim 1 wherein one or more sensors measure the direction of the wind, the one or more sensors sending one or more wind direction measurements to the controller, and the controller determining the yaw angle of the wind turbine relative to the wind direction based on the measurements.

4. The method of claim 3 wherein the one or more sensors comprise a wind vane.

5. The method of claim 1 wherein the yaw angle of the wind turbine is changed to decrease the rotation speed of the one or more blades when the wind speed reaches a predetermined upper limit.

6. A system for controlling the yaw angle of a nacelle on a wind turbine, the system comprising:
a yaw clutch mechanically connected between a yaw motor and the nacelle;
the yaw clutch able to move to a closed position when power is applied to the yaw clutch and able to move to an open position in the absence of power;
wherein, in the closed position, the yaw motor is mechanically engaged to the nacelle to control the yaw angle of the nacelle, and, in the open position, the yaw motor is disengaged from the nacelle and the nacelle is able to yaw independently from the yaw motor.

7. The system of claim 6 wherein one or more blades are rotatably connected to the nacelle, the one or more blades comprising a front surface and a back surface, the back surface being shaped to be less aerodynamic than the front surface.

8. The system of claim 7 wherein, when the yaw clutch is in the open position, the nacelle yaws freely to face down wind so that the wind blows against the back surface of the one or more blades.

9. The system of claim 6 further comprising a controller to control the yaw motor and the yaw angle of the nacelle, the controller also controlling the opening and closing of the yaw clutch, whereby when there is a loss of power to the controller, the yaw clutch moves to the open position.

10. The system of claim 6 wherein the nacelle yaws about a support, the system further comprising:
a stationary ring gear on the support;
the yaw motor mounted in the nacelle, the yaw motor configured to drive a shaft;
the yaw clutch interposed between a spur gear and the shaft, the spur gear mechanically engaged with the ring gear; and,
wherein, when the yaw clutch is in the closed position, the spur gear and the shaft are mechanically connected and, when the yaw clutch is in the open position, the spur gear and the shaft are disengaged.

11. The system of claim 6 wherein the yaw clutch is electromagnetic.

12. A system for controlling a wind turbine comprising:
a wind turbine generator powered by the rotation of a rotor having one or more blades of the wind turbine;
an inverter electrically connected to the generator, the inverter able to increase the electrical current drawn from the generator to reduce the rotational speed of the one or more blades;
a resistor and a switch, the switch electrically connected between the resistor and the generator, whereby the switch is closed and opened repeatedly to pulse the voltage produced from the generator, thereby reducing the rotational speed of the one or more blades; and,
a controller that is configured to repeatedly open and close the switch upon detecting that the current draw from the inverter has reached a current draw limit or that the rotational speed of the one or more blades has reached a rotational speed limit.

13. The system of claim 12 wherein the wind turbine comprises a nacelle that holds the generator, and the system further comprises a yaw motor mechanically engaged with the nacelle to change the yaw angle of the nacelle, the yaw motor controlled by the controller; and,
wherein the controller is configured to change the yaw angle of the nacelle relative to the direction of the wind to reduce the rotational speed of the one or more blades, upon detecting that the one or more blades has reached the rotational speed limit.

14. The system of claim 13 wherein the controller is configured to change the yaw angle of the nacelle to reduce the rotational speed of the one or more blades also upon detecting that the length of time that the switch has been closed and opened repeatedly to pulse the voltage has reached a time limit.

15. The system of claim 13 further comprising a normally closed switch that is electrically connected in parallel to the switch, whereby when power is applied to the normally closed switch, the normally closed switch is in an open position, and in the absence of power, the normally closed switch is in a closed position to direct current from the generator to the resistor, thereby reducing the rotational speed of the one or more blades.

16. The system of claim 15 wherein the normally closed switch is controlled by the controller, and the controller is configured to close the normally closed switch upon detecting that the one or more blades has reached the rotational speed limit.

17. The system of claim 16 further comprising a normally closed brake able to mechanically engage a generator shaft, whereby when power is not applied to the normally closed brake, the normally closed brake is in a closed position engaging the generator shaft to reduce the rotational speed of the one or more blades.

18. The system of claim 17 further comprising:
a normally open yaw clutch mechanically connected between the yaw motor and the nacelle;
the yaw clutch able to move to a closed position when power is applied to the yaw clutch and able to move to an open position in the absence of power; and,
wherein, in the open position, the yaw motor is disengaged from the nacelle and the nacelle is able to yaw freely to face down wind so that the wind blows against a back surface of the one or more blades, the back surface shaped to be less aerodynamic than a front surface of the one or more blades, so that when facing down wind, the rotational speed of the one or more blades is reduced.

19. The system of claim 18 wherein at least a first and a second power line are electrically connected to the generator, and the system further comprising a shunt switch that, when closed, produces an electrical short between the first and second power lines of the generator to reduce the rotational speed of the one or more blades.

20. The system of claim 19 wherein the controller is configured to activate a first control combination comprising increasing the current draw from the inverter and repeatedly opening and closing the switch, upon detecting that the rotational speed limit has been reached;
the controller is configured to activate a second control combination comprising changing the yaw angle of the nacelle and activating the first control combination, upon detecting that the rotational speed limit has been reached while the first control combination is active;
the controller is configured to activate a third control combination comprising closing the normally closed switch and activating the second control combination, upon detecting that the rotational speed limit has been reached while the second control combination is active;
the controller is configured to activate a fourth control combination comprising closing the normally closed brakes and activating the third control combination, upon detecting that the rotational speed limit has been reached while the third control combination is active;
the controller is configured to activate a fifth control combination comprising opening the normally open yaw clutch and activating the fourth control combination, upon detecting that the rotational speed limit has been reached while the fourth control combination is active; and,
the controller is configured to activate a sixth control combination comprising closing the shunt and activating the fifth control combination, upon detecting that the rotational speed limit has been reached while the fifth control combination is active.
